(19) United States
(12) Patent Application Publication
(10) Pub. No.: US 2020/0018792 A1
(43) Pub. Date: Jan. 16, 2020

(54) Electronic Interface for Configuring Electronic Communications in Electronic Testing

(71) Applicant: David Webster, Murrieta, CA (US)

(72) Inventor: David Webster, Murrieta, CA (US)

(21) Appl. No.: 16/034,263

(22) Filed: Jul. 12, 2018

(51) Int. Cl. G01R 31/3177; G01R 31/28; G06F 21/76; G06F 21/78; H04L 9/08

(52) U.S. Cl. CPC G01R 31/3177; G01R 31/2844; G01R 31/2889; G06F 2221/2143; G06F 21/78; H04L 9/0894; G06F 21/76

(57) ABSTRACT

An insertable interface component employing a binary load into volatile memory or field-programmable gate array (FPGA) configured for testing input and output operations of an electronic component. The interface component allows testing while preventing firmware hacking and alteration by segregating classified data and communications during equipment testing.

### 1. FIELD OF THE INVENTION

The present invention relates generally to logic analyzing and analytic methods employed by technicians using electronic testing components for troubleshooting electronic signals used for communications between multiple electronic devices. More particularly, the invention relates to an insertable interface component, employing a binary load into volatile memory or field-programmable gate array (FPGA) configured for input and output operations of the device, to prevent firmware hacking and alteration and to segregate classified data and communications during equipment testing, to thereby significantly increase security in electronic testing devices such as a logic analyzers used for troubleshooting high security electronic devices which employ electronic keys as well as differing electronic protocols for communications, such as those used for military and government electronic communication.

### 2. PRIOR ART

Electronic communication between computers and interfaced or intervening communications components and systems and related technologies are well known, but ever evolving. With the advent of computer and other electronic data communication between transmitting and receiving devices, electronic signals carrying data to be used for communicating and for initiating action by remote receiving devices and components, are sent over a communications channel between a sending electronic component and receiving electronic component. Such communications are generally made using particular electronic protocols which communicate the electronic data between two or more electronic devices, in a format employable by both devices.

Modernly, such electronic signals in the chosen protocols carry data on a communications channel which can be local, or be carried over distances of a few miles or thousands of miles. Further, such communications have gotten more sophisticated over time through the employment of differing electronic signal protocols. For instance, the well known RS-232 protocol is still widely employed today electronics equipment.

Additionally, such electronic communications have also been rendered more secure through the employment of encoded and scrambled electronic signals. Such electronic signals when sent to a receiving device, require one or more electronic keys upon receipt, for the receiving device to decrypt the transmitted electronic data and thereby render it useable by the receiving device.

Unfortunately, as the distance and/or number of connections and components positioned between the source of a digital message and its destination increase, and with signal traveling over multiple networks and through multiple reception and transmission devices, accurate reception of transmitted data at the reception point, becomes increasingly more problematic. This problem is exacerbated when different electronic communication protocols are employed in a single message. It is further complicated when the electronic data transmitted is encrypted and requires electronic keys to decrypt for use. The problem of useable electronic communication is further exacerbated due to physical defects in cables used along electronic communications pathway, which can affect the actual electronic transmission, the configuration of the signal according protocols, and the encryption. Further physical defects in the electronic pathway can cause problems with the accurate communication of electronic signals in one chosen signal protocol, but may not affect a different signaling protocol.

Inaccurate or unusable electronic data transmission in such electronic signaling can result from numerous defective communication sources along a transmission pathway which generally result in electronic noise being communicated into an electronic signal. Such can occur due to wire breaks, frayed wires, or where connections have corroded or become loose, where an electronic card or portion thereof is defective, or for a plethora of other reasons. This problem of an errant signal being received in an unusable fashion, becomes a communication nightmare where the electronic signal is both in an electronic protocol more affected by noise, and/or which is encrypted in a manner where signal noise renders the electronically encrypted signal unuseable even with the proper key.

Further, electronic and digital communications rely on highly accurate signal timing and transmission and reception standards to communicate the transmitted data in an accurate fashion to from the transmission point and along the electronic pathway to the reception point. A flawed transmission component, or reception component, or a damaged line, or low or high voltage, or spurious magnetic fields, or many other problems can electronically affect the electronic signal communication along the electronic pathway between transmission and reception. Such can easily result in damaged or unusable data at a reception component.

Further, such electronic communication of data employs ever changing standards along with frequently implemented differing hardware or software or both, to communicate the electronic signals along a pathway on a channel and to subsequently unlock and/or decode the signal at the endpoint to achieve accurate reception of transmitted data. Such accurate decoding of the arriving electronic signal on a communications channel is a requirement for the received data to be employable for the intended task or action to be imitated.

As noted, in addition to the potential for flaws in the operation of transmission and reception components, and bugs in operating software, another source of flawed digital communications result from the electrical distortion of the electronic signals which when transmitted, travel through long conductors along a signal pathway. The longer the pathway the signal must follow on the communications channel, the more potential exists for electronic noise to be added to the electronic signal transmitted from physical problems such as a wiring flaw, corroded or loose cable connectors, errant magnetic fields and the like. Thus, as a transmitted signal using one or more communication protocols propagates through a transmission medium or pathway, the longer the signal physically travels between the transmission and reception point, the more potential exists for noise being imparted to the signal.

While inside a small facility, precautions can be taken to protect the electronic communications and data exchange between the transmission and reception components, the problems caused by electronic noise significantly increase when data is transferred between devices over a network, or plurality of engaged networks. In many cases, the resulting distortion of a received signal from a transmission point, can become so severe that information sent to a receiving point on the communications channel is lost or severely impaired.

Such a communications channel is essentially a pathway over which information or data may be communicated. The channel may travel over a physical wire that connects communicating devices, or by a wireless communication employing RF or a laser, or other radiated energy sources. The data sent through such communications channel has a source from which the information originates using one or more transmission protocols and a destination point of delivery of the data which must discern the transmitted protocol and then employ the software or electronic components employing that protocol to obtain data from the transmitted signal. Although information or data may originate and transmit from a single source, there may be more than one destination, depending upon how many receiving stations are linked to the communications channel, and how much energy the transmitted signal possesses.

In a digital communications channel, the data or information is communicated in the form of individual data bits, which may be encapsulated into multi bit message units. A byte, which consists of eight bits, is an example of a message unit that may be conveyed through a digital communications channel. A collection of bytes may itself be grouped into a frame or other higher-level message unit depending on the communications protocol of the transmission. These levels of data encapsulation facilitate the handling of communications in a complex data communications network.

Most digital messages are significantly longer than just a few bits and are broken into smaller parts and transmitted over the communication channel sequentially and reassembled at the reception point. A plurality of different wiring or communication channels may provide multiple pathways for the message segments, which are then reassembled at the reception point using the electronic signal protocol for such. Such a reassembly is frequently dependent on the communications protocol used by the transmission device, which defines the order and meaning of the received bits in the transmission, so that the transmission may be reassembled at the receiving point properly. The protocol may also specify a procedure for exchanging messages, error-correction, and other information controlling the hardware which is employed for sending and receiving the electronic communications over the electronic communication pathway.

However, as noted above, noise and electrical disturbances such as voltage variances or frequency variances, EMF energy, and other types of electrical interference, impart a high potential to cause random or non-continuous signal anomalies in the electronic signal transmitted across the channel from the source. Such electrical anomalies can easily cause changes in the transmitted all or segmented portions of data as it passes through a communications channel which render some portions unemployable during reassembly with the appropriate protocol or which yield errors in the communication on reassembly.

Such issues, of course, can cause a significant change in the discerned data on the receiving end of the channel using the appropriate protocol for deciphering transmission, thus communicating unuseable or intelligible data to the reception point. The potential for such data transmission errors also can occur where the transmission hardware using electronic components for generating the electronic signal according to the protocol used, or with the reception hardware itself. These malfunctions can be caused by malfunctioning components yielding errors in the signal varying in timing or from the transmission protocol employed, or the receiving electronic device can also error in discerning the incoming signal due to malfunctioning components.

For the technician attempting to ascertain a source of an electronic data communication problem, where a signal reception point or device suffers from lost or unusable data or impaired electronic data communications on one or more communications channels, a problem arises. The technician has to discern if the errant signal reception is due to electrical disturbances caused by physical defects or EMF along the pathway for the electronic signal, or whether the errant received signal is caused by the component transmitting it, or whether the signal received is useable but the component receiving the electronic signal is flawed or employing the wrong protocols due to timing or the like.

Thus, in making an assessment of an electronic communication error the technician is faced with a significant problem. To fix the problem, the technician must discern if there is lost or corrupted electronic data and if so, whether such loss is a result of hardware, wiring, software, electronic noise, momentary electrical disturbances such as voltage spikes or frequency or timing variances, or other issues, when attempting to repair or eliminate unusable electronic signals causing lost or poor data reception.

The replacement of electronic transmission and reception hardware is frequently not possible at the transmission point if it happens to be remote from the technician working on a local component. Further, in the case of highly sophisticated equipment such highly secure computing systems, or aircraft electronic equipment, or military equipment, replacing actual components would be an expensive and time consuming option at either the transmission point or reception point.

Reloading of software or firmware into the electronic equipment involved in the transmission and reception of data carried on an electronic signal is also prone to its own set of potential problems. In the case of military equipment, aircraft, and expensive and highly secure computing components, such is just not an option, in most cases, due to the secret and highly secure nature of the data communicated, the software, firmware, protocols and the equipment on which it resides.

Consequently, it is imperative that the technician be able to ascertain whether an electronic signal causing the lost or unusable data received at a reception point is actually caused by transmission or reception hardware or component firmware, or software, or the communications line or channel carrying the signal therebetween, before initiating a repair to those components or systems.

Data encryption is also well known in the art of electronic transmission to maintain data proceeding to, and arriving at a receiving end as confidential. Encrypted data employs any number of transmission and reception protocols and additionally is communicated using cryptographic keys which encode the signal. In this fashion, the actual content of the communication cannot be ascertained until the receiving end component employs the correct protocol and the communicated key, whereafter the signal is decoded to yield intelligible data. Simple key loaders (SKL) are a type of fill device which load such cryptographic keys to communication signals carried on the channel. Thus, SKLs employed at the sending and receiving end of a telecommunication channel provide the first line of communication.

When the communicated data is encrypted, it is required for the receiving component to employ the correct electronic signal protocol and the proper key to decode the communicated signal in order to ascertain and use the communicated data. Subsequently, the receiving component is enabled to employ the proper key to discern the data content of the communicated signal on the channel.

Encrypted data, in the case of governments, often includes content which may be highly classified. As such, when analyzing communications where encrypted classified data is transmitted to the receiving component, users are typically unable to access the content of the data for the purpose of analyzing such signals for a proper transmission and response. This is because they lack the proper security clearance to review the received data to ascertain if discernable communications between two devices are being transmitted and received.

The disclosed device and system herein provides for an improved device and method for monitoring, reviewing and analyzing electronic analog and digital communications over an electronic pathway or channel where encrypted and classified communications take place. The system provides an interface device, positioned within the electronic pathway between a first transmission and receiving device and a second transmission and receiving device. In this position and connected to a testing computing device, and employing software, and simple key loaders which load the proper cryptographic keys for the communication signals carried on the channel which are loaded to volatile electronic memory which will passively zeroize upon disconnection, the system herein provides testing-employable non classified data responses initiated by a transmission of classified data. Any classified data in an electronic signal from the first transmission and receiving component is intercepted by the electronic interface and converted to a non classified but useable data response for testing the electronic equipment awaiting the electronic response.

Employing the device and method herein, a technician with minimal security clearance can use the device to test an electronic transmission and receiving component, where that electronic component requires the electronic transmission of classified data to the component being tested. Further security is provided by the interface device which, upon being disconnected from the power source, will immediately passively zeroize and remove all loaded software and operating instructions and any preloaded keys or software protocols employed in transmitting and receiving electronic transmissions.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision of a cabling connector interface, which is configured with cable ports for operative engagement with one or a plurality of electronic cable connectors for communications cables providing an electronic pathway between a first transmitting and receiving component and one being tested. Positioned in between input and output ports engageable with cables running between the first transmission and receiving component and the one being tested, the device includes a computing component. The computing component or computer includes a microprocessor and electronic memory which may be populated with the required software and electronic protocols and keys required to transmit and receive electronic communications between the first electronic transmission and receiving component and the electronic transmission and reception component being tested.

Additionally, or in place of electronic memory, the computer includes a field-programmable gate array (FPGA) which is an integrated circuit (IC) that may be programmed in the field after manufacture with software instructions to operate the computing device within the interface. FPGAs are similar in principle to, but have vastly wider potential application than, programmable read-only memory (PROM) chips which are used to control overall operations of a computing device.

In the computing device positioned within the cable interface herein, the FPGA is loaded with software configured to operate the computer during a testing of communications between the first transmission and receiving component and the transmission and receiving component being tested. The operating instructions of the software loaded to the FPGA are customized to the task where the electronic protocols, keys, and other communication requirements required for proper communication between the first transmission and reception device and the one being tested.

Removal of operative connection of electric power from the FPGA and/or any random access member or RAM, upon completion of testing, will thereby passively zeroize and delete any and all codes, keys, software, communication protocols, and operating instructions, which are preloaded into RAM and/or the FPGA, prior to initiating the testing. Such will occur once a cable connecting the interface component to a testing component is disengaged. This will provide a significant increase in security of testing.

During testing of the transmission and receiving device being tested, which may frequently require an electronic response which includes encrypted and classified data, the computer, within the electronic interface, will prevent the communication of such a response to the device being tested which includes such classified data. Instead, the communicated electronic data transmitted from the first transmission and receiving device containing classified data, will be received by the computing component on the electronic interface, and the classified data will be substituted with an electronic response generated by the computing device. This electronic response will be generated based on the classified data in the response signal, and will include an electronic response which will be discerned as a proper electronic response being expected by the device being tested. However, while being propagated and sent in a fashion to be discerned as a proper response, it will not include non classified data. The transmission and receiving device being tested will, thus, be provided an electronic response which will be recognized as proper to discern any line or component problems in communication. However, the data sent will be viewable by the technician for that purpose since it does not contain classified information.

With respect to the above description, before explaining at least one preferred embodiment of the herein disclosed invention in detail, it is to be understood that the invention is not limited in its application to the details of construction and to the arrangement of the components or steps noted in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed communications testing interface. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and FIGURES disclosed herein are to be considered illustrative rather than limiting. In the drawings:

FIG. 1 depicts the electronic cable interface herein removably engaged between a first electronic transmission and reception device, and one being tested, and with a computer employed to view and test electronic communications.

Other aspects of the present invention shall be more readily understood when considered in conjunction with the accompanying drawings and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

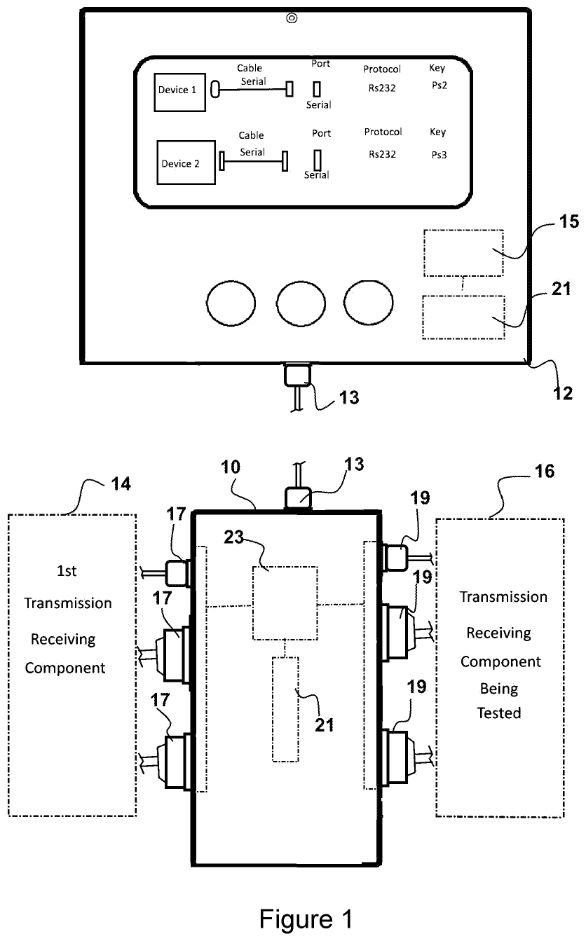

Now referring to drawings in FIG. 1, there is seen in FIG. 1 the interface device 10 herein, which is to be engaged to a testing computing device 12 running software configured to the task of monitoring electronic communications between a first transmission and receiving component 14 and a second transmission and receiving component 16 sending and receiving electronic signals through the interface device 10, and determining a source for miscommunication, such as electronic parts or cabling between the two.

The interface device 10, receives all electric power to operate solely from a testing connection 13 to the computing device 12 hosting the testing software. The interface device 10 has electronic memory 21 into which is first loaded the appropriate keys and codes required for communicating with the first transmission and receiving component 14, which will transmit classified data signals, based thereon, to the second transmission and receiving component 16.

The computing device 12, as noted, has analyzing software running in electronic memory 15 connected to a microprocessor 21, which is configured to the task of monitoring, reviewing and analyzing electronic analog and digital signals during communications over an electronic pathway or channel between the first transmission and receiving component 14 and the second transmission and receiving component 16.

The interface device 10, positioned within the electronic pathway between the first transmission and receiving device 14 and a second transmission and receiving device 16 and operatively connected to the computing component 12, has key loading software loaded into volatile electronic memory 21 of the interface device 10. This key loading software is configured to operate to the task of providing a simple key loader which will load the proper cryptographic keys for the communication signals carried on the channel running between the first transmission and receiving component 14 and the second transmission and receiving component 16.

The interface device 10 additionally has at least two cable connectors 17 and 19 and can have multiple cable connectors of differing configurations to form a communication connection between the first transmission and receiving component 14 shown connected to the first cable connector 17 and the second transmission and receiving component 16 shown connected to the second cable connector 19. Electronic pathways between the cable connectors 17 and 19 are formed internally in a conventional fashion running through the microprocessor 23 of the interface device 10 which can be a circuit board with processors and electronic memory and built in or software controlled communications channels thereon, as needed, to pass the electronic data signals between the first and second transmission and receiving components.

The keyloading software and any keys allowing for communications between the first and second transmission and receiving components are initially loaded to energized volatile electronic memory 21 of the interface device 10, prior to testing. The loaded electronic keys and keyloaders will thereafter passively zeroize when the device 10 is de-energized upon disconnection of the sole electric power source from the computing component 12 which solely provides all electric power to run the circuits, microprocessor 23 and maintain data in electronic memory 21.

Once interfaced in between the first transmission and receiving component 14 and second transmission and receiving component 16, the interface device 10 will receive data transmissions between the first transmission and receiving component 14 and the second transmission and receiving component 16, and intercept electronic data responses between the two components which is a classified data stream employing the loaded keys, and instead generate and substitute a testing-employable but non classified data stream or data response.

The non classified data responses generated by data stream generating software running in electronic memory 21 of the interface device 10 and which operates to receive electronic classified data or data streams in response to electronic communications requiring the keys held in volatile memory between the first and second transmission and receiving components. The data stream generating software, recognizing that a communicated data stream required transmission of a key loaded to memory 21, will then generate usable but non classified data communication to be sent to either of the first transmission receiving component 14 or the second transmission and receiving component 16 which is awaiting a useable data response to operate during testing.

In this fashion, the interface device 10 allows electronic communications of the first transmission and receiving component 14 and second transmission and receiving component 16 to be discerned as normal communication therebetween. This is because the data stream generating software will generate, from the data stream containing classified communications which is recognized as containing or using the loaded cryptographic keys held in volatile memory 21, a secondary electronic data stream which is awaited by and will be recognized by the listening one of the first transmission and receiving component 14 or second transmission and receiving component 16. In this fashion, the data stream generating software operating in electronic memory of the interface device 10 will substitute a secondary or non classified data stream communicated electronically and viewable by the technician, to ascertain the communication is actually taking place between the two components. Concurrently, the technician can test for defects in cabling, components, communications channels, and other issues which can cause miscommunication during the back and fort communication of secondary electronic data steams between the first transmission and receiving component 12 and second transmission and receiving component 14. However, all such secondary electronic data streams generated by the data stream generating software upon recognizing the keys loaded to volatile memory which may or do contain classified data or communications, are substituted with a data stream recognized by the receiving component 12 or 14 as proper but which contain only non classified data.

In a method for testing such communications, the technician would be provided the interfaced device 10 operatively engaged and electrically powered by a computing component 12 which would have a wired channel with the interface device 10 to test communications running through the interface device 10 and between the first transmission and receiving component 14 and the second transmission and receiving component 16.

Software will be loaded into volatile electronic memory 21 of the interface device 10 which operates to the task of providing a simple key loader which will load and communicate the proper cryptographic keys for the communication signals, carried on the channel running between the first transmission and receiving component 14 and the second transmission and receiving component 16.

Data stream generating software operating to the task of accepting electronic data communications which are classified which is determined by the need for a cryptographic key in the key loader, which is received into electronic memory 21 from the first transmission and receiving component 14 or the second transmission and receiving component 16 by the interface device 10, will then operate to substitute the discerned classified data stream with a non-classified data stream. This generated non classified data stream, when received by either of the first transmission and receiving component 14 or the second transmission and receiving component 16, is generated to be recognized as a proper response during communications.

Testing software running in electronic memory and on a processor in the computing component 12 will thereby be able to sample and discern electronic communications between the first and second transmission and receiving components 12 and 14 operating in a normal fashion and thereby determine if there are electronic equipment or electronic lines causing any miscommunication of the electronic data streams. This is because each of the first and second electronic transmission and receiving components 12 and 14 connected by the device 10, will continue to operate because they receive an awaited data stream of non classified data in place of a classified data stream, and such, so generated, is always discerned as an acceptable electronic communication.

Such will, thus, allow the two transmission and receiving components 12 and 14 to continuously communicate electronically in a normal fashion as would occur with classified data streams, but instead using non classified data streams substituted by the data stream generating software operating in electronic memory to that task. While the components communicate in a normal fashion with the non classified data streams, the equipment, electronic cables, and other physical components causing miscommunication can be discerned.

While all of the fundamental characteristics and features of the electronic interface for configuring electronic communications in electronic testing have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A communications testing apparatus, comprising:
an interface component having a first cable connector operatively engaged with a first communications cable connectable to a first electronic transmission and receiving component;
said interface component having a second cable connector operatively engaged with a second communications cable connectable to a second electronic transmission and receiving component;
said interface component having a microprocessor engaged with electronic memory;
said microprocessor and electronic memory powered by electric power from a removably engageable testing connection with a computing component;
software operating in said electronic memory to the task of temporarily storing cryptographic keys required for transmissions of electronic data between said first electronic transmission and receiving component and said second electronic transmission and receiving component;
data stream generating software operating in said electronic memory to the task of intercepting classified electronic data communicated in an electronic communication between said first electronic transmission and receiving component and said second electronic transmission and receiving component and substituting non classified electronic data therefor in said electronic communication; and
said electronic memory configured to passively zeroize upon a disconnection of said testing connection resulting in cessation of communication of said electric power to said interface component, whereby said cryptographic keys and any said classified electronic data are permanently erased from said electronic memory.
